(19) United States
(12) Patent Application Publication
(10) Pub. No.: US 2026/0343377 A1
(43) Pub. Date: Oct. 29, 2026

(54) Non-primary channel access in wireless communications

(71) Applicant: Synaptics Incorporated, San Jose, CA (US)

(72) Inventors: Girish Anantrao Madpuwar, Bangalore (IN); Saishankar Nandagopalan, San Diego, CA (US); Patil Sandhya, Bangalore (IN)

(73) Assignee: Synaptics Incorporated, San Jose, CA (US)

(21) Appl. No.: 19/189,064

(22) Filed: Apr. 24, 2025

(51) Int. Cl. H04W 40/12; H04W 4/06; H04W 16/02; H04W 28/02

(52) U.S. Cl. CPC H04W 40/12; H04W 4/06; H04W 16/02; H04W 28/0278

(57) ABSTRACT

A method, device, and system of centralized coordination for switching between a primary channel and a non-primary channel using the access point. After detection of overlapping basic service set (OBSS) interference on the primary channel, the access point sends a channel switch request to all associated stations using overlapping basic service set (OBSS) packet detection (PD)-based spatial reuse (SR). The access point determines which stations received the channel switch request based on responses from the stations on either the primary channel or the non-primary channel. The access point may then communicate with responding stations on the non-primary channel.

### TECHNICAL FIELD

The present implementations relate generally to wireless communications, and more specifically, to non-primary channel access in wireless networks.

### BACKGROUND OF RELATED ART

A wireless local area network (WLAN) may be formed by one or more access points (APs) that provide a shared wireless communication medium for use by a number of client devices, which are referred to as stations (STAs). The fundamental unit of a WLAN, e.g., as defined by the Institute of Electrical and Electronics Engineers (IEEE) 802.11 standards, is the Basic Service Set (BSS), which is managed by an AP and includes associated STAs. The BSS may be identified by a basic service set identifier (BSSID) that is advertised in beacon frames that are periodically broadcast by the AP. The beacon frames enable STAs that are within wireless range of the AP to establish and maintain a communication link with the AP in the WLAN.

In congested environments, such as office buildings, apartments, public Wi-Fi zones, etc., a wireless device (such as an AP or a STA) may contend for access to a wireless channel. If the wireless medium is occupied, the wireless device may switch to another wireless channel and refrain from using the occupied channel for a period of time. The condition of the wireless medium, however, is relative. For example, the wireless medium may appear busy for some members of the WLAN but may not appear busy for other members of the WLAN. Consequently, some devices in the WLAN may switch to one or more wireless channels, while other devices may remain on the initial wireless channel, leading to non-optimal and inefficient performance.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method for wireless communication performed by a first wireless device. The first wireless device obtains an indication of interference on a first channel and transmits a channel switch request using overlapping basic service set packet detect (OBSS-PD) with spatial reuse (SR) to one or more second wireless devices to switch from the first channel to a second channel. The first wireless device receives a response from at least one of the one or more second wireless devices and transmits communications on the second channel to the one or more of the second wireless devices.

Another innovative aspect of the subject matter of this disclosure can be implemented in a wireless communication device that includes one or more processors, and a memory. The memory stores instructions that, when executed by the processing system, cause the wireless device to obtain an indication of interference on a first channel, and transmit a channel switch request using overlapping basic service set packet detect (OBSS-PD) with spatial reuse (SR) to one or more second wireless devices to switch from the first channel to a second channel. The wireless device may be further caused to receive a response from at least one of the one or more second wireless devices, and transmit communications on the second channel to the one or more of the second wireless devices.

Another innovative aspect of the subject matter of this disclosure can be implemented in a method for wireless communication performed by a first wireless device. The first wireless device receives a channel switch request from a second wireless device to switch from the first channel to a second channel. The first wireless device transmits a response to the second wireless device, and receives communications on the second channel from the second wireless device.

Another innovative aspect of the subject matter of this disclosure can be implemented in a wireless communication device that includes one or more processors, and a memory. The memory stores instructions that, when executed by the processing system, cause the wireless device to receive a channel switch request from a second wireless device to switch from the first channel to a second channel. The wireless device may be further caused to transmit a response to the second wireless device, and receive communications on the second channel from the second wireless device.

### BRIEF DESCRIPTION OF THE DRAWINGS

The present implementations are illustrated by way of example and are not intended to be limited by the figures of the accompanying drawings.

FIG. 1 shows a block diagram of a wireless network.

FIG. 2 shows a block diagram of a wireless network that includes overlapping the Basic Service Sets (BSS).

FIG. 3 illustrates a resource diagram supporting the use of an access point as a centralized controller to coordinate the switch between the primary channel and secondary channel, as discussed herein.

FIG. 4 illustrates example formats of trigger frames, including a trigger frame that may be used for the channel switch request.

FIG. 5 illustrates another resource diagram supporting the use of an access point as a centralized controller to coordinate the switch between the primary channel and secondary channel, as discussed herein.

FIGS. 6A and 6B show block diagram of an example access point and station, respectively, that may be used with centralized control for channel switching, as discussed herein.

FIG. 7 shows an illustrative flowchart depicting an example operation for wireless communication implemented by an access point, as discussed herein.

FIG. 8 shows an illustrative flowchart depicting an example operation for wireless communication implemented by a station, as discussed herein.

### DETAILED DESCRIPTION

In the following description, numerous specific details are set forth in order to provide a thorough understanding of the innovative aspects of this disclosure. It will be understood by those skilled in the art, however, that the present disclosure may be practiced in a multitude of different ways. In other instances, well-known methods, procedures, components, and details from known standards have not been described in detail so as to obscure the present disclosure. The implementations described herein may be implemented in any device, system or network that is capable of transmitting and receiving radio frequency (RF) signals according to one or more of the Institute of Electrical and Electronics Engineers (IEEE) standards, including the IEEE 802.11 standards, as well as the IEEE 802.15 standards, the Bluetooth® standards as defined by the Bluetooth Special Interest Group (SIG), or the Long Term Evolution (LTE), 3G, 4G or 5G standards, among others. The described implementations may also be implemented using other wireless communication protocols or RF signals suitable for use in one or more of a wireless personal area network (WPAN), a wireless local area network (WLAN), a wireless wide area network (WWAN), or an internet of things (IOT) network.

Some wireless networks support the use of multiple channel access, e.g., where wireless devices may use multiple channels or sub-channels to communicate with other wireless devices. For example, under IEEE standards, such as the 802.11 standards, transmission and reception of RF signals is supported over an operating bandwidth. To facilitate communications, a primary channel within the operating bandwidth is used for transmissions, such as for critical control frames, such as beacons, acknowledgments, association requests, as well as discovery. In some environments, however, such as office buildings, apartments, public Wi-Fi zones, etc., the channel may be congested resulting in, e.g., higher latency, lower throughput, and increased packet collisions. To mitigate these issues, transmission on non-primary channels in the operating bandwidth is sometimes permitted, e.g., as introduced in 802.11ac (Wi-Fi 5) and improved in 802.11ax (Wi-Fi 6).

Non-primary channel access, however, has several important constraints. For example, co-existence ensures that 802.11be (Wi-Fi 7) and older devices (Wi-Fi 6/5/4, etc.) prioritize the primary channel for communication. Devices that do not support multi-link or non-primary channel access will only recognize and operate on the primary channel, ignoring any transmissions on secondary channels. Thus, legacy devices might not be aware of activity on non-primary channels, requiring Wi-Fi 7 devices to ensure compatibility by always maintaining communication over the primary channel. Another constraint is medium blindness, in which a device that transmits on a non-primary channel, is temporarily unable to sense activity on the primary channel. Medium blindness means that a device may miss important transmissions on the primary channel, leading to potential collisions or lost packets. Devices must be conservative when re-accessing the primary channel after using non-primary channels. For example, devices may be required to wait before transmitting to ensure that the primary channel is still available and reduce interference with other devices. Such constraints on the use of non-primary channel access, however, result in under-utilization of device capabilities.

One proposed solution to these limitations leverages the capabilities of the transmitter and receiver. For example, if the transmitter and receiver are able to perform a full Clear Channel Assessment (CCA) in parallel on multiple channels, the CCA may be performed sequentially on other channels when the primary channel is busy. Another proposed solution is based on the use of a non-primary anchor channel, which is a channel to which the transmitter and receiver would move if the primary channel is busy. The non-primary anchor channel, for example, may be any 20 MHz channel in the operating bandwidth such that that the frame exchange covers at least one anchor channel. When the primary channel is busy, both the transmitter and receiver move to the next agreed upon anchor channel. Another proposed solution is based on the use of the multi-user request to send (MU-RTS) mechanism followed by polling for all devices present on the non-primary channel. The frame exchange, for example, may then be initiated with devices that moved to the non-primary channel.

Unfortunately, the proposed solutions lack coordination, which may lead to non-optimized behaviors in the network. The state of the wireless medium varies by location; for instance, the wireless medium may appear congested at the location of the transmitter but may appear clear at the location of a receiver. Switching to a non-primary channel with the proposed solutions is not coordinated between the transmitter and the receivers and, accordingly, may result in errors. For example, one device may switch to a non-primary channel because the primary channel appeared congested, while another device that is at a different location may believe the primary channel is clear and accordingly will remain on the primary channel. If more than one non-primary anchor channel is used, the state of the non-primary anchor channels may also vary by location, and thus, one device may find a first non-primary channel uncongested and may remain on that channel, while another device may find the first non-primary channel congested and change to a second non-primary channel. Moreover, due to the absence of signaling, after a device moves to a non-primary channel, it will remain there for the Network Allocation Vector (NAV) duration, while another device did not switch and remains on the primary channel. In this instance, transmissions between devices will result in failure and frame discard due to the retry limit. Thus, the lack of coordination and signaling may lead to non-optimal performance in the network.

As discussed herein, a signaling mechanism is used to coordinate the switch between a primary channel and a non-primary channel, sometimes referred to as a secondary channel. The coordination of the switching is managed by a centralized controller. For example, an access point may serve as the centralized controller and coordinate the switching between primary and secondary channels. In some implementations, the access point, for example, may use overlapping basic service set (OBSS) packet detection (PD)-based spatial reuse (SR) signaling to coordinate switching without otherwise affecting existing frame exchanges.

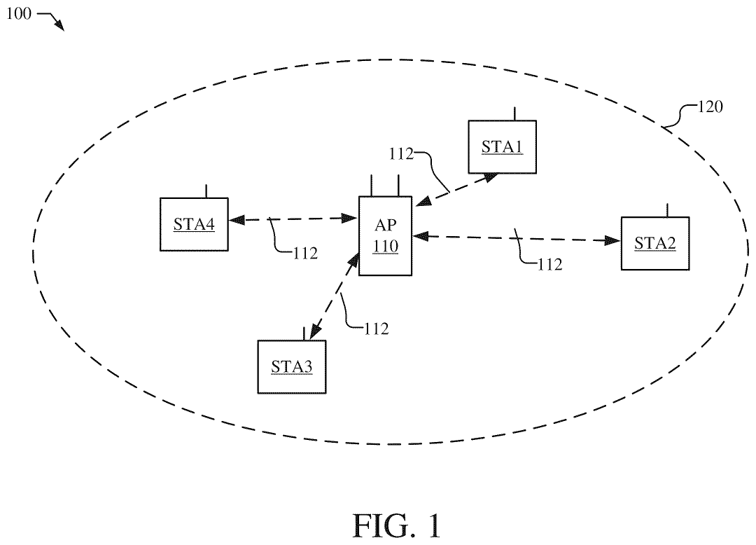

FIG. 1 shows a block diagram of a wireless network 100. The wireless network 100, which may sometimes be referred to as a Wireless Local Area Network (WLAN), may be an example of a Wi-Fi network, e.g., implementing at least one of the IEEE 802.11 family of wireless communication protocol standards. The wireless network 100 includes an access point (AP) 110 and a number of wireless stations STA1-STA4. Although four wireless stations STA1-STA4 are shown in FIG. 1 for simplicity, it is to be understood that the wireless network 100 may include any number of STAs.

Each of the wireless stations STA1-STA4 may be referred to as a mobile station (MS), a mobile device, a mobile handset, a wireless handset, an access terminal (AT), a user equipment (UE), a subscriber station (SS), or a subscriber unit, among other examples. The wireless stations STA1-STA4 may represent any suitable wireless device including mobile phones, personal digital assistant (PDAs), other handheld devices, netbooks, notebook computers, laptop computers, Chromebooks, tablet devices, wearable devices, display devices, music or other audio or stereo devices, printers, kitchen appliances (such as smart refrigerators), Internet of Things (IoT) devices, or the like.

The AP 110 wirelessly communicates with the stations STA1-STA4 via associated communication links 112. Additionally, the AP 110 may enable the various stations STA1-STA4 to communicate with one another access external networks. The AP 110 may be any suitable device that allows one or more wireless devices to connect to a network (such as a local area network (LAN), wide area network (WAN), metropolitan area network (MAN), or the Internet) using Wi-Fi, Bluetooth, or any other suitable wireless communication standards. In some implementations, the AP 110 may be any suitable wireless device (such as a wireless STA) acting as a software-enabled access point (“SoftAP”). The AP 110 and stations STA1-STA4 may each include one or more transceivers, one or more processing resources (such as processors or ASICs), one or more memory resources, and a power source.

The AP 110 and associated stations STA1-STA4 may correspond to a basic service set (BSS), which is managed by the AP 110. The BSS represents a basic building block of a wireless network and thus includes a single AP (such as AP 110) and one or more associated STAs (such as STA1-STA4). FIG. 1 additionally illustrates an example coverage area 120 of the AP 110, which may represent a basic service area (BSA) of the WLAN. The BSS may be identified or indicated to users by a service set identifier (SSID), or to other devices by a basic service set identifier (BSSID), which may be a medium access control (MAC) address of the AP 110. Beacon frames (“beacons”) may be periodically broadcast by the AP 110, and may include the BSSID to enable stations, e.g., stations STA1-STA4, within the coverage area 120 of the AP 110 to associate or re-associate with the AP 110 to establish or maintain a respective communication link 112 with the AP 110. The beacons may identify a primary channel used by the respective AP 110 as well as a timing synchronization function for establishing or maintaining timing synchronization with the AP 110.

The stations STA1-STA4 may establish respective communication links 112 with the AP 110 by performing passive or active scanning operations (“scans”) on frequency channels in one or more frequency bands (for example, the 2.4 GHZ, 5 GHZ, 6 GHz or 60 GHz bands). For passive scanning, stations listen for beacons that are periodically transmitted by APs. For active scanning, the stations may generate and sequentially transmit probe requests on each channel to be scanned and listens for probe responses from the APs. Each station STA1-STA4 may identify and select an access point, e.g., AP 110, with which to associate, based on the scanning information obtained through the passive or active scans, and perform authentication and association operations to establish the respective communication link 112 with the selected AP 110.

In crowded environments, a station may be able to select to associate with one of multiple APs that are within range. After association, a station may periodically scan to find a more suitable access point, such as when the station is moving relative to an associated access point. The station may find a different access point having more desirable network characteristics such as a greater received signal strength indicator (RSSI) or a reduced traffic load and may associate with the new access point accordingly.

The AP 110 and stations STA1-STA4 transmit and receive wireless communications, via the respective communication links 112, e.g., according to one or more of the IEEE 802.11 family of wireless communication protocol standard. The wireless communications between the AP 110 and stations STA1-STA4 may be over an unlicensed spectrum, which may be a portion of spectrum that includes frequency bands traditionally used by Wi-Fi technology, such as the 2.4 GHZ band, the 5 GHz band, the 60 GHz band, the 3.6 GHz band, and the 900 MHz band, or in other frequency bands, such as the 5.9 GHZ and the 6 GHz bands, which may support both licensed and unlicensed communications, or over other frequency bands such as shared licensed frequency bands.

Each of the frequency bands may include multiple sub-bands or frequency channels. For example, wireless communications conforming to the IEEE 802.11n, 802.11ac, 802.11ax and 802.11be standard amendments may be transmitted over the 2.4 GHZ, 5 GHz or 6 GHz bands, each of which is divided into multiple 20 MHz channels. As such, these wireless communications are transmitted over a physical channel having a minimum bandwidth of 20 MHz, but larger channels can be formed through channel bonding, e.g., physical channels having bandwidths of 40 MHZ, 80 MHz, 160 or 320 MHz by bonding together multiple 20 MHz channels.

While FIG. 1 illustrates a single wireless network 100, it should be noted that in some environments, multiple wireless networks may exist. Moreover, in some environments, such as office buildings, apartments, public Wi-Fi zones, etc., multiple APs may be assigned overlapping frequency channels, which may result in higher latency, lower throughput, and increased packet collisions as multiple devices try to communicate simultaneously.

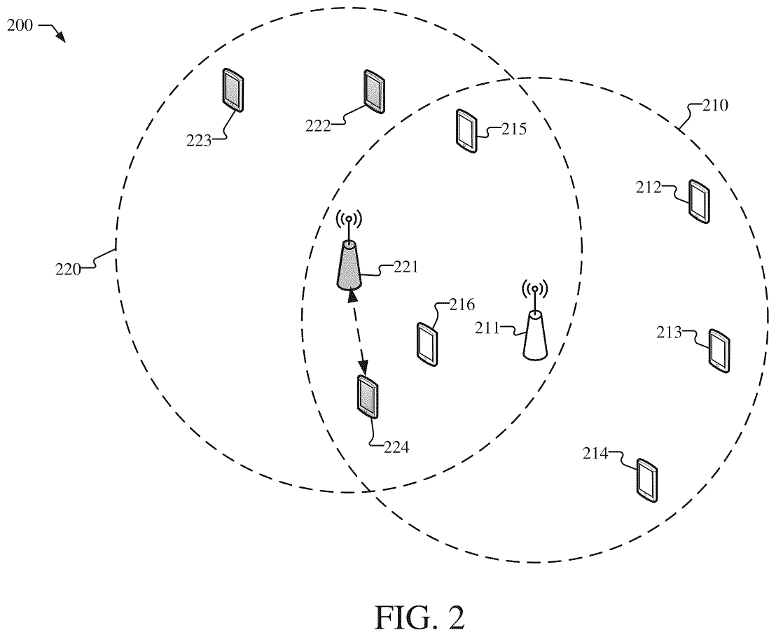

FIG. 2 shows a block diagram of a wireless network 200 that includes overlapping BSSs 210 and 220. Each of BSS 210 and 220 may be similar to the BSS illustrated in wireless network 100 shown in FIG. 1. As illustrated in FIG. 2, the BSS 210 includes AP 211 and associated stations 212-216, while BSS 220 includes AP 221 and associated stations 222-224. The coverage areas of the BSS 210 and 220 (shown with dotted circles) overlap such that the APs 211 and 221 and stations 215 and 224 are located within the overlapping coverage area, while stations 212, 213, 214, 222, and 223 are located outside of the overlapping coverage area. As indicated by the dashed arrow, AP 221 and station 224 of BSS 220 may be engaged in a frame exchange resulting in overlapping BSS (OBSS) interference with BSS 210.

As discussed above, the perceived condition of the wireless medium may vary depending on location. For example, BSS 210 devices, e.g., the AP 211 or station 216, which are located within the overlapping coverage area, may detect the OBSS interference from the frame exchange between the AP 221 and station 224, while stations 212, 213, 214, which are outside of the overlapping coverage area may not see the same interference.

The OBSS interference may be detected by the AP 211 or the station 216, for example, through the use of carrier sense multiple access (CSMA) with collision avoidance (CA) (CSMA/CA) techniques. For example, before transmitting data, the wireless communication device may perform a clear channel assessment (CCA) to determine whether the relevant wireless channel is idle. The CCA, for example, may use physical carrier sensing which is based on measured signals or energy on the channel, or virtual carrier sensing, which uses protocol level information to infer channel occupancy.

Physical carrier sensing is a real-time detection by a device of signals or energy on the medium. For example, the received signal strength of a detected preamble of a valid frame may be measured and compared to a threshold to determine whether the channel is busy. Physical carrier sensing may also measure the total energy level on a channel, regardless of whether a valid frame is detected. If the measured energy on the channel exceeds a threshold, the channel may be considered busy.

Virtual carrier sensing, on the other hand, infers channel occupancy based on protocol level information, such as the network allocation vector (NAV). The NAV effectively serves as a time duration that must elapse before the device may contend for access on the channel. For example, when a device detects a valid frame on the channel, the device updates its NAV timer and refrains from transmitting until the timer expires, regardless of the physical channel conditions. When the NAV expires, the device may perform the physical carrier sensing. If the channel remains idle for a specific time, e.g., inter-frame space (IFS) period, the device may initiate a backoff timer that represents a duration of time that the device senses the medium to be idle before it is permitted to transmit. If the channel remains idle until the expiration of the backoff timer, the device may begin transmitting. On the other hand, if there is an indication by one or more of the carrier sense mechanisms that the channel is busy, a MAC controller within the device will not permit transmission on the channel.

According to aspects of the present disclosure, when OBSS interference is detected, the devices in a BSS, e.g., AP 211 and stations 212-216 in BSS 210, may switch from a primary channel to a secondary, i.e., non-primary, channel. The OBSS interference may be detected by the AP 211 or may be detected by a station, such as station 216. Regardless of the device that detects the OBSS interference, the AP 211 will serve as a centralized controller to coordinate the switch between the primary channel and secondary channel.

In order to function as the centralized controller, the AP may include the capability of performing a CCA assessment in parallel on multiple channels in its operating bandwidth. In some implementations, the CCA assessment performed by the AP may include both physical carrier sensing and virtual carrier sensing on multiple channels. If the CCA performed by the AP indicates that the primary channel is busy, the CCA assessment of other channels continues until an idle channel is found. Thus, the AP is aware of the condition of the wireless medium, including when the primary channel or one or more of the secondary channels are busy.

With the AP, e.g., AP 211 in FIG. 2, serving as the centralized controller for switching channels, the stations in the BSS, e.g., stations 212-216 in BSS 210, do not need to independently perform CCA assessments on multiple channels. The stations may be capable of CCA on only the primary channel. In some optional implementations, one or more of the stations may be capable of performing a CCA assessment in parallel on multiple channels. If a station, e.g., station 216, detects OBSS interference on the primary channel, the station may send a report of the medium condition to the AP 211, e.g., using a medium status frame, which may be referred to as MedStatFrame. In some implementations, if a station, e.g., station 216, detects OBSS interference on the primary channel, the station may send a channel switch request to the AP.

Once the AP 211 obtains an indication of OBSS interference on the primary channel, e.g., detected by the AP 211 or by station 216, the AP 211 functions as the centralized controller and transmits a channel switch request on the primary channel to stations 212-216 in the BSS 210 with an indication to switch from the primary channel to the secondary channel. In some implementations, the AP 211 may determine if there is sufficient time for the channel switch before initiating the channel switch. The channel switch request, for example, may identify the secondary (non-primary) channel, the channel switch time, i.e., the time to switch to the secondary channel, and the maximum time that it will be on the secondary channel. The maximum time, for example, may be determined by the AP 211 based on the medium reservation (NAV) from the OBSS frame exchange minus the overhead due to, e.g., channel switch frame, switch time, interframe space (IFS), etc. For example, the AP 211 may send one or more broadcast or multicast change switch requests and may poll the associated stations for the reliability of the frame exchange, and the channel switch time may account for these additional frames. The AP 211 may initiate the channel switch by multicasting or broadcasting the channel switch request on the primary channel to the stations 212-216 to switch from the primary channel to a secondary channel.

In some implementations, the AP 211 may send the channel switch request using OBSS-PD based SR. OBSS-PD based SR, introduced in 802.11ax, permits a device to transmit even if it detects an OBSS frame, provided the signal strength (RSSI) of detected OBSS frame is below a dynamic threshold (OBSS-PD threshold). OBSS-PD uses a higher, adjustable threshold for OBSS frames than the fixed threshold used to block transmission with traditional CCA, thereby enabling spatial reuse if the interference is deemed tolerable (below the OBSS-PD threshold). For OBSS-PD based SR, each BSS tags its frame with a color, e.g., a 6-bit identifier. If a device detects a frame with a different color, OBSS-PD rules may be applied instead of the standard CCA. For example, if the device detects and identifies an OBSS frame, e.g., via the BSS color, the device measures the received signal strength of the OBSS frame. If the measured signal strength is below the OBSS-PD threshold, the device will consider the medium as sufficiently idle for spatial reuse. The OBSS-PD threshold, for example, may be adjusted based on the transmit power of the device, where a lower transmit power allows a higher threshold, encouraging reuse while minimizing interference. The device, thus, may transmit on the primary channel even while the OBSS interference continues. Thus, if the AP 211 detects OBSS interference, it may transmit the channel switch request on the primary channel even while the OBSS interference continues using OBSS-PD based SR. Similarly, if the station 216 detects the OBSS interference, the station 216 may use OBSS-PD based SR to transmit a report of the detected OBSS interference or a request to switch channels to the AP 211 based on the detected interference. Upon receiving the report or request to switch channels from the station 216, as the centralized controller, AP 211 may decide to perform the channel switch or not, e.g., based on whether the AP 211 also sees interference or if a plurality of stations report interference or request to switch channels. If the AP 211 decides to perform the channel switch, the AP 211 may send, e.g., via multicast or broadcast, the channel switch request to stations 212-216.

The receiving stations 212-216 must receive and decode the channel switch request amidst potential OBSS interference. Accordingly, the reception status of the channel switch request for each of the stations 212-216 will be unknown to the AP 211 until the AP 211 receives a response from one or more of the stations 212-216. In some implementations, any station that received and decoded the channel switch request may respond with an acknowledgement to the AP 211. In some implementations, the AP 211 may poll the stations on the secondary channel to determine which stations received and decoded the channel switch request and switched to the secondary channel. For example, after sending the channel switch request, the AP 211 may switch to the secondary channel and send a trigger frame, such as a buffer status report poll (BSRP), on the secondary channel. Any station that switched to the secondary channel may respond to the trigger frame, e.g., with an uplink null frame. Thus, in some implementations, the AP 211 may switch to the secondary channel before receiving the response from the stations, while in other implementations, the AP 211 may receive the response from the stations before switching to the secondary channel.

After the AP 211 receives a response from one or more of the stations 212-216, the AP 211 may begin transmitting communications on the secondary channel to the responding stations for frame exchanges. After transmitting the communications on the secondary channel, i.e., performing the frame exchange, the AP 211 may switch back to the primary channel. In some implementations, the AP 211 may provide a reverse channel switch request to the one or more of the stations 212-216 that are on the secondary channel to switch back to the primary channel. Additionally, in some implementations, the channel switch request transmitted by the AP 211 may include the maximum time that it will be on the secondary channel. The stations 212-216 that are on the secondary channel may switch back to the primary channel after the maximum time. For example, if one or more of the stations 212-216 on the secondary channel miss the reverse channel switch request, the stations may switch back to the primary channel after the maximum time.

Thus, in a scenario in which AP 211 detects the OBSS interference, the channel switch operation, with AP 211 serving as the centralized controller, may be performed as follows. The AP 211 may detect a frame exchange between AP 221 and station 224, e.g., via a CCA assessment. The AP 211 may decode the control frame exchange between the AP 221 and station 224 and detect the medium reservation, e.g., the NAV for the OBSS frames (inter-BSS NAV in 802.11ax). The AP 211 further determines if the signal strength of the OBSS transmission between AP 221 and station 224 is lower than the OBSS-PD threshold. If the signal strength is lower than the OBSS-PD threshold, the AP 211 sends the channel switch request, e.g., via multicast or broadcast, to all stations 212-216 of the BSS 210.

In another scenario, the station 215 detects the OBSS interference and the channel switch operation, with AP 211 serving as the centralized controller, may be performed as follows. In this scenario, the station 215 may detect a frame exchange between AP 221 and station 224, e.g., via a CCA assessment. The station 215 may decode the control frame exchange between the AP 221 and station 224 and detect the medium reservation, e.g., the NAV for the OBSS frames (inter-BSS NAV in 802.11ax). The station 215 further determines if the signal strength of the OBSS transmission between AP 221 and station 224 is lower than the OBSS-PD threshold. If the signal strength is lower than the OBSS-PD threshold, the station 215 sends a report or a channel switch request to the AP 211, e.g., indicating the inter-BSS NAV. After receiving the report or channel switch request from the station 215, the AP 211 may send the channel switch request, e.g., via multicast or broadcast, to all stations 212-216 of the BSS 210.

Regardless of the device that detected the OBSS interference, some stations in the BSS 210 may not successfully receive and decode the channel switch request sent by the AP 211. For example, station 216 may not receive the channel switch request due to excessive interference from AP 221. In this example, stations 212-215, however, successfully receive and decode the channel switch request.

To determine which stations were able to receive and decode the channel switch request, the AP 211 may perform a handshake with stations on the secondary channel. For example, the AP 211 may switch to the secondary channel and send a trigger frame, e.g., BSRP trigger, to confirm the presence of stations on the secondary channel. In the present example, only stations 212-215 switch to the secondary channel and will respond to the trigger frame, e.g., with an uplink null frame. In another example, the stations 212-215 that received and decoded the channel switch request may respond to the channel switch request, e.g., with an acknowledgement, before the AP 211 and stations 212-215 switch to the secondary channel. Station 216 did not receive and decode the channel switch request and accordingly will not switch to the secondary channel or respond to the AP 211. Station 216 will need to wait until the OBSS interference is gone and the return of the AP 211 to the primary channel before receiving further frame exchanges with AP 211 on the primary channel.

Once the AP 211 is on the secondary channel and is aware that stations 212-215 received the channel switch request, the AP 211 may perform the frame exchange with the stations 212-215 on the secondary frame for the duration of the inter-BSS NAV. At the end of the inter-BSS NAV, the AP 211 and stations 212-215 switch back to the primary channel. For example, the AP 211 may send a reverse channel switch request and/or the maximum time on the secondary channel (provided in the initial channel switch request) may expire.

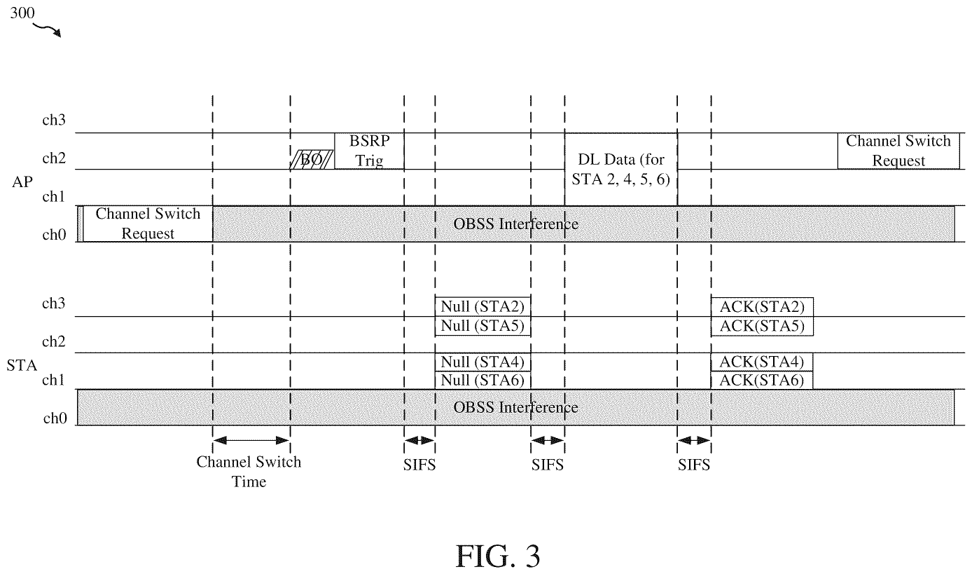

FIG. 3, by way of example, illustrates a resource diagram 300 supporting the use of an access point (AP) as a centralized controller to coordinate the switch between the primary channel and secondary channel with a number of associated stations (STA2, STA4, STA5, and STA6), as discussed herein. FIG. 3 illustrates an implementation in which the AP switches from the primary channel (ch0) to a secondary channel (ch2) before receiving responses from associated stations.

In FIG. 3, the channel 0 (ch0) is the primary channel, while channel 1 (ch1), channel 2 (ch2), and channel 3 (ch3), are secondary, non-primary channels. As illustrated with gray shading, OBSS interference is present on the primary channel (ch0). The AP obtains an indication of the OBSS interference on the primary channel (ch0), e.g., either by detecting the OBSS interference or by receiving a report from one of the associated stations indicating that OBSS interference is present.

The AP sends the channel switch request, which may be sent via multicast or broadcast, to the associated stations. The channel switch request, for example, may be presented as a trigger frame.

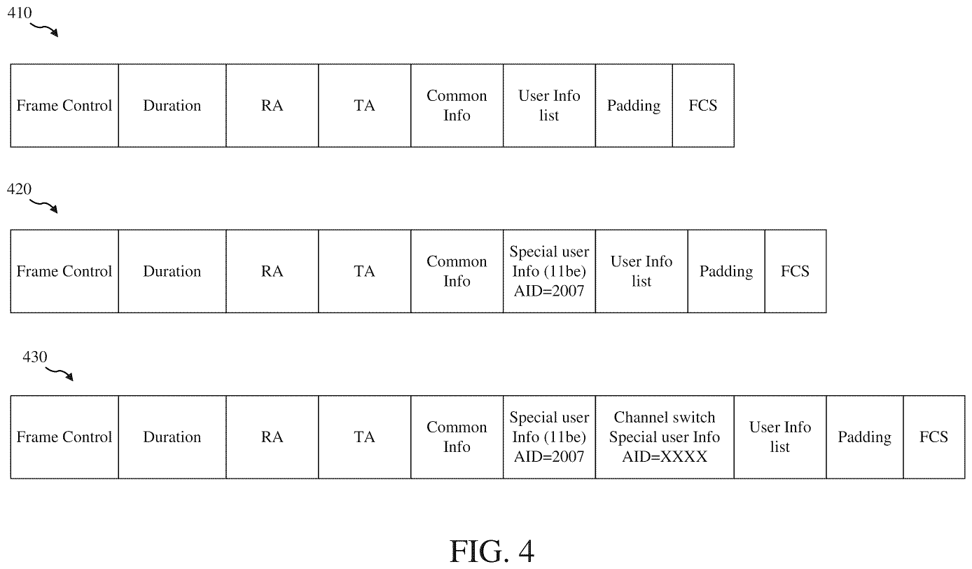

FIG. 4, by way of example, illustrates example formats of trigger frames 410 and 420 under 802.11ax (Wi-Fi 6) and 802.11be (Wi-Fi 7), and one implementation of a format for a trigger frame 430 that may be used for the channel switch request.

Trigger frame 410 illustrates the trigger frame format under 802.11ax (Wi-Fi 6), which includes a MAC header including a frame control field, duration field, RA (receiver address) field, and TA (transmitter address). The trigger frame 410 further includes fields for common information, user information, padding, and FCS (frame check sequence). The trigger frame 420 illustrates the trigger frame format under 802.11be (Wi-Fi 7), which is similar to trigger frame 410, and includes a special user information field.

Trigger frame 430, which may be similar to trigger frame 420 (or trigger frame 410), may be used by the AP for the channel switch request. As illustrated, the trigger frame 430 may include a channel switch special user information field, which may be serve as the channel switch request if the Association Identifier (AID) value is matched to a specified value, indicated as “XXXX”. The channel switch special user information field may include relevant channel switching parameters, such as the new channel number. The channel switch special user information field may further include the channel switch time, e.g., the time to switch to the secondary channel. The AP, for example, may send one or more multicast or broadcast channel switch requests and may determine the reliability of the frame exchange by polling the associated stations. The channel switch time included in the channel switch request may account for the additional frame on air. The channel switch special user information field may further include the maximum time that the station will remain on the secondary channel, e.g., so that the station will switch back to the primary channel after the maximum time unless the station receives an earlier reverse channel switch request.

Referring back to FIG. 3, once the channel switch request is sent, after a channel switch time (which may be included in the channel switch request), the AP switches from the primary channel (ch0) to a non-primary, secondary channel (ch2). After a backoff (BO) period, the AP may poll the associated stations on the secondary channel to determine which stations switched. The AP, for example, may transmit a trigger frame, such as a buffer status report poll (BSRP), on the secondary channel to poll the stations. After a short interframe space (SIFS), one or more of the stations that switched to the secondary channel in response to the channel switch request, illustrated as stations ST2, STA4, STA5, and STA6, respond to the trigger frame, e.g., as an uplink null frame. As illustrated, the stations switch from the primary channel (ch0), but may switch to one or more of the secondary channels, e.g., ch1, ch2, or ch3.

After receiving the responses from the stations ST2, STA4, STA5, and STA6, the AP may begin transmitting communications on the secondary channel to the responding stations ST2, STA4, STA5, and STA6 to perform the frame exchange. For example, as illustrated in FIG. 3, the AP may transmit downlink data to the responding stations over the secondary channel, and after a SIFS, the stations may transmit an uplink acknowledgment that is received by the AP. In some implementations, the frame exchange may include the AP transmitting a trigger frame, followed by one or more stations transmitting uplink data that is received by the AP, and the AP transmits a downlink acknowledgement to the transmitting stations.

After completion of the frame exchange, the AP may transmit a reverse channel switch request to the responding stations ST2, STA4, STA5, and STA6, to switch from the secondary channel back to the primary channel. In some implementations, the initial channel switch request transmitted by the AP may include the maximum time that a station will remain on the secondary channel. The stations on the secondary channel may switch back to the primary channel (ch0) after the maximum time has elapsed (which may be included in the channel switch request) or in response to the reverse channel switch requests. For example, if the stations on the secondary channel miss the reverse channel switch request, the stations will switch back to the primary channel after the maximum time.

In some implementations, prior to sending the channel switch request, the AP may determine if there is sufficient time for the channel switch. The AP may only initiate the channel switch if there is sufficient time, e.g., to switch from the primary channel to the secondary channel, perform the frame exchange, and switch back to the primary channel. For example, as discussed above, the frame exchange on the secondary channel may include polling the stations on the secondary channel (e.g., using a BSRP trigger), receiving a response from one or more of the stations (e.g., using an uplink null frame) in addition to transmitting downlink data, and receiving an uplink acknowledgement, or transmitting a trigger, receiving uplink data, and transmitting a downlink acknowledgment.

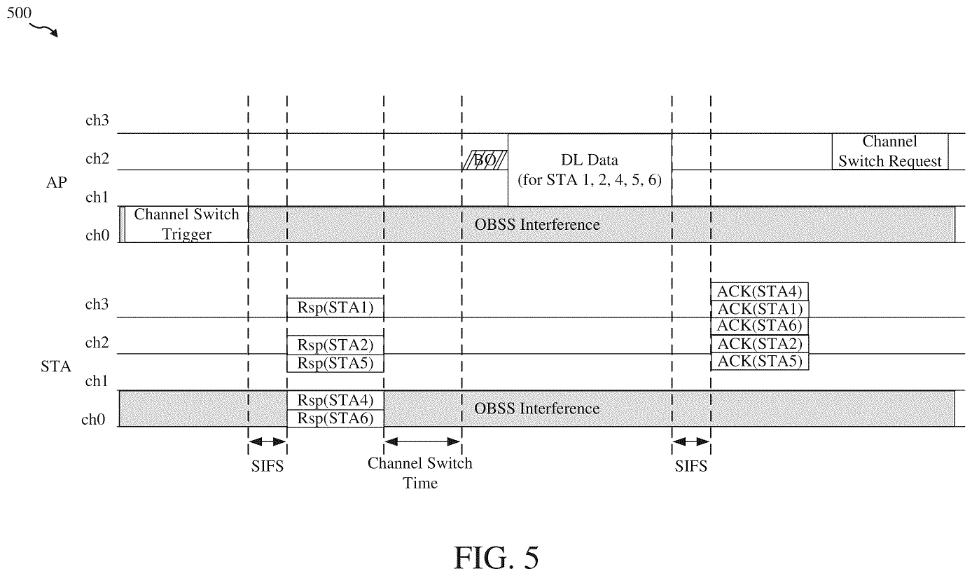

FIG. 5, by way of example, illustrates another resource diagram 500 supporting the use of an access point (AP) as a centralized controller to coordinate the switch between the primary channel and secondary channel with a number of associated stations (STA1, STA2, STA4, STA5, and STA6), as discussed herein. FIG. 5 illustrates an implementation in which the AP switches from the primary channel (ch0) to a secondary channel (ch2) after receiving responses from associated stations.

Similar to FIG. 3, the channel 0 (ch0) is the primary channel, while channel 1 (ch1), channel 2 (ch2), and channel 3 (ch3), are secondary, non-primary channels, and OBSS interference is present on the primary channel (ch0), as illustrated with gray shading. The AP may obtain an indication of the OBSS interference on the primary channel (ch0) directly or from one or more associated stations.

As illustrated, the AP sends the channel switch request, which may be sent via multicast or broadcast, to the associated stations. The channel switch request, for example, may be presented as a trigger frame, e.g., as discussed in FIG. 4. The one or more of the stations that received the channel switch request may respond to the AP after a SIFS. The response, for example, may be an acknowledgement that is transmitted in an uplink orthogonal frequency-division multiple access (OFDMA) frame, which may be transmitted on the primary channel (ch0) or a secondary channel. After receiving the responses from the one or more of the stations, and after a channel switch time (which may be included in the channel switch request), the AP switches from the primary channel (ch0) to a non-primary, secondary channel (ch2). After a backoff period, the AP may begin transmitting communications on the secondary channel to the responding stations STA1, STA2, STA4, STA5, and STA6 to perform the frame exchange. For example, as illustrated in FIG. 5, the AP may transmit downlink data to the responding stations over the secondary channel, and after a SIFS, the stations may transmit an uplink acknowledgment that is received by the AP. In some implementations, the frame exchange may include the AP transmitting a trigger frame, followed by one or more stations transmitting uplink data that is received by the AP, and the AP transmits a downlink acknowledgement to the transmitting stations.

After completion of the frame exchange, the AP may transmit a reverse channel switch request to the responding stations STA1, STA2, STA4, STA5, and STA6, to switch from the secondary channel back to the primary channel, as discussed in reference to FIG. 3. For example, in some implementations, the initial channel switch request transmitted by the AP may include the maximum time that a station will remain on the secondary channel. The stations on the secondary channel may switch back to the primary channel (ch0) after the maximum time has elapsed (which may be included in the channel switch request) or in response to the reverse channel switch requests. For example, if the stations on the secondary channel miss the reverse channel switch request, the stations will switch back to the primary channel after the maximum time.

As discussed above, in some implementations, prior to sending the channel switch request, the AP may determine if there is sufficient time for the channel switch, and the AP may only initiate the channel switch if there is sufficient time, e.g., to switch from the primary channel to the secondary channel, perform the frame exchange, and switch back to the primary channel. For example, the frame exchange on the secondary channel may include transmitting downlink data and receiving an uplink acknowledgement, or transmitting a trigger, receiving uplink data, and transmitting a downlink acknowledgment.

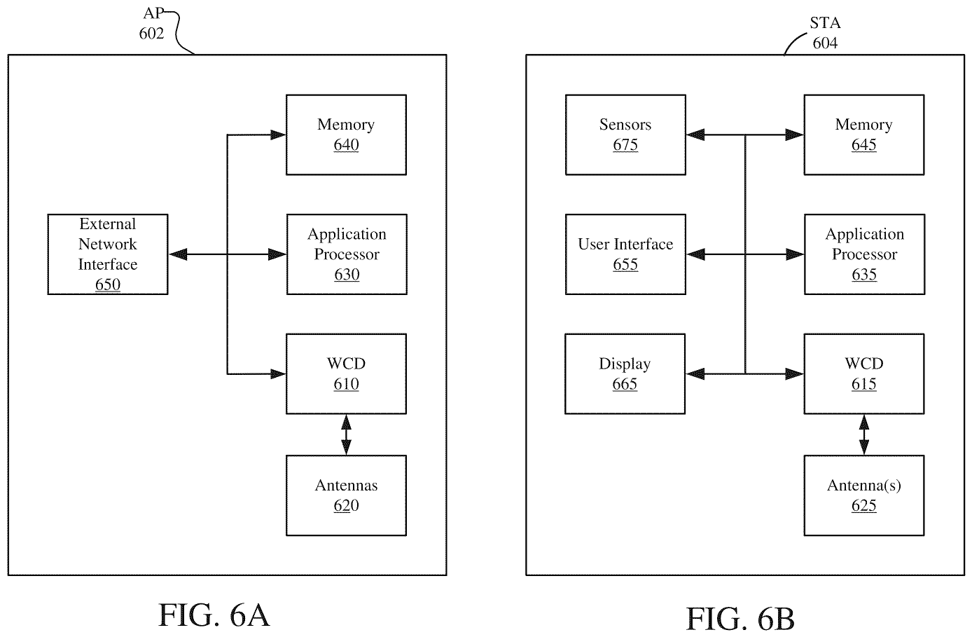

FIG. 6A shows a block diagram of an example AP 602 that may be used as a centralized controller for channel switching, as discussed herein. For example, the AP 602 may be an implementation of the AP 211 described with reference to FIG. 2, or the AP discussed in reference to FIGS. 3 and 5. The AP 602 includes a wireless communication device (WCD) 610 (although the AP 602 may itself also be referred to generally as a wireless communication device). The AP 602 also includes multiple antennas 620 coupled with the wireless communication device 610 to transmit and receive wireless communications. In some implementations, the AP 602 additionally includes an application processor 630 coupled with the wireless communication device 610, and a memory 640 coupled with the application processor 630. The AP 602 further includes at least one external network interface 650 that enables the AP 602 to communicate with a core network or backhaul network to gain access to external networks including the Internet. For example, the external network interface 650 may include one or both of a wired (for example, Ethernet) network interface and a wireless network interface (such as a WWAN interface). Ones of the aforementioned components can communicate with other ones of the components directly or indirectly, over at least one bus. The AP 602 further includes a housing that encompasses the wireless communication device 610, the application processor 630, the memory 640, and at least portions of the antennas 620 and external network interface 650.

The memory 640 may include a non-transitory computer-readable medium (including one or more nonvolatile memory elements, such as EPROM, EEPROM, Flash memory, or a hard drive, among other examples) that may store software (SW) modules that include instructions that, when executed by the application processor 630, causes the AP 602 to perform the corresponding functions, e.g., as discussed herein. For example, the application processor 630 may include any suitable one or more processors capable of executing scripts or instructions of one or more software programs stored in the AP 602 (such as in the memory 640). For example, the application processor 630 may be configured to obtain an indication of interference on a primary channel, e.g., by CCA, or by receiving a report or channel switch request from a station. The application processor 630 may be configured to prepare and transmit a channel switch request using overlapping basic service set packet detect (OBSS-PD) with spatial reuse (SR) to one or more stations to switch from the primary channel to a non-primary, secondary channel. The application processor 630 may be configured to receive a response from one or more stations. For example, the application processor 630 may be configured to transmit a trigger frame on the secondary channel and receive the responses from the one or more stations on the secondary channel or the application processor 630 may be configured to receive the response, e.g., as an acknowledgment of the channel switch request, from the one or more stations on the primary channel. The application processor 630 may be configured to transmit communications on the secondary channel to the responding stations. The application processor 630 may be further configured to switch back to the primary channel, as discussed herein.

FIG. 6B shows a block diagram of an example station 604 that may communicate with an AP acting a centralized controller for channel switching, as discussed herein. For example, the station 604 may be an example implementation of the station 216 described with reference to FIG. 2 or any of the stations discussed in reference to FIGS. 3 and 5. The station 604 includes a wireless communication device 615 (although the station 604 may itself also be referred to generally as a wireless communication device as used herein). The station 604 also includes one or more antennas 625 coupled with the wireless communication device 615 to transmit and receive wireless communications. The station 604 additionally includes an application processor 635 coupled with the wireless communication device 615, and a memory 645 coupled with the application processor 635. In some implementations, the station 604 further includes a user interface (UI) 655 (such as a touchscreen or keypad) and a display 665, which may be integrated with the UI 655 to form a touchscreen display. In some implementations, the station 604 may further include one or more sensors 675 such as, for example, one or more inertial sensors, accelerometers, temperature sensors, pressure sensors, or altitude sensors. Ones of the aforementioned components can communicate with other ones of the components directly or indirectly, over at least one bus. The station 604 further includes a housing that encompasses the wireless communication device 615, the application processor 635, the memory 645, and at least portions of the antennas 625, UI 655, and display 665.

The memory 645 may include a non-transitory computer-readable medium (including one or more nonvolatile memory elements, such as EPROM, EEPROM, Flash memory, or a hard drive, among other examples) that may store software (SW) modules that include instructions that, when executed by the application processor 635, causes the station 604 to perform the corresponding functions, e.g., as discussed herein. For example, the application processor 635 may include any suitable one or more processors capable of executing scripts or instructions of one or more software programs stored in the station 604 (such as in the memory 645). For example, the application processor 635 may be configured to detect an OBSS on the primary channel, and transmit a message on the primary channel to the access point indicating the OBSS, e.g., using OBSS-PD based SR. The application processor 635 may be configured to receives a channel switch request from an access point to switch from a primary channel to a non-primary, secondary channel. The application processor 635 may be further configured to transmit a response to the access point. For example, the application processor 635 may be configured to receive a trigger frame on the secondary channel and transmit a response to the access point on the secondary channel or the application processor 635 may be configured to transmit the response, e.g., as an acknowledgment of the channel switch request, to the access point on the primary channel. The application processor 635 may be further configured to receive communications on the secondary channel from the access point. The application processor 635 may be further configured switch back to the primary channel after receiving a reverse channel switch request or after ta maximum time on the secondary channel has elapsed.

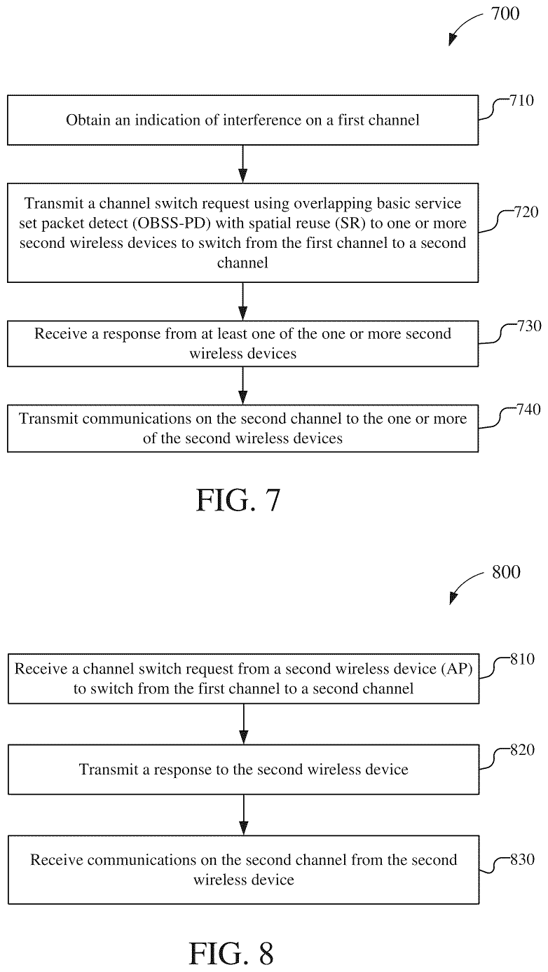

FIG. 7 shows an illustrative flowchart depicting an example operation 700 for wireless communication, according to implementations discussed herein. In some implementations, the example operation 700 may be performed by a first wireless device, such as an access point including AP 211 or AP 602 shown in FIGS. 2 and 6A, respectively, or discussed in reference to FIGS. 3-5.

As illustrated in FIG. 7, the first wireless device obtains an indication of interference on a first channel (710), e.g., as discussed in reference to AP 211 in FIG. 2. In some implementations, the first wireless device may obtain the indication of interference on the first channel by detecting an overlapping basic service set (OBSS) on the first channel, e.g., as discussed in reference to AP 211 in FIG. 2. In some implementations, the first wireless device may obtain the indication of interference on the first channel by receiving a message on the first channel from one of the second wireless devices indicating an overlapping basic service set (OBSS) on the first channel, e.g., as discussed in reference to station 216 in FIG. 2.

The first wireless device transmits a channel switch request using overlapping basic service set packet detect (OBSS-PD) with spatial reuse (SR) to one or more second wireless devices to switch from the first channel to a second channel (720), e.g., as discussed in reference to AP 211 and stations 212-216 in FIG. 2, and discussed in reference to the channel switch request in FIGS. 3-5.

The first wireless device receives a response from at least one of the one or more second wireless devices (730), e.g., as discussed in reference to AP 211 and stations 212-215 in FIG. 2 and discussed in reference to the uplink null frame in FIG. 3 and the acknowledgment in FIG. 5.

The first wireless device transmits communications on the second channel to the one or more of the second wireless devices (740), e.g., as discussed in reference to AP 211 and stations 212-215 in FIG. 2 and discussed in reference to the frame exchange in FIGS. 3 and 5.

In some implementations, the first wireless device may transmit the channel switch request by transmitting one of a multicast or broadcast message on the first channel with the channel switch request, and switching from the first channel to the second channel, and transmitting a trigger frame on the second channel to poll the plurality of second wireless devices that switched to the second channel, wherein the response from at least one of the one or more second wireless devices is received after switching from the first channel to the second channel and transmitting the trigger frame, e.g., as discussed in FIGS. 2 and 3. The trigger frame, for example, may be a buffer status report poll (BSRP). The response received from the one or more of the second wireless devices, for example, may be an uplink null frame from each of the one or more of the second wireless devices.

In some implementations, the first wireless device may transmit the channel switch request by transmitting one of a multicast or broadcast message on the first channel with the channel switch request, and switching from the first channel to the second channel after receiving the response from one or more of the second wireless devices, wherein the communications are transmitted on the second channel to the one or more of the second wireless devices after a channel switch delay, e.g., as discussed in FIGS. 2 and 5. The response received from the one or more of the second wireless devices, for example, may be an acknowledgement transmitted in an uplink orthogonal frequency-division multiple access (OFDMA) frame from each of the one or more of the second wireless devices.

In some implementations, the channel switch request may include a maximum time on the second channel, as discussed in FIG. 2.

In some implementations, the first wireless device may switch from the second channel back to the first channel after transmitting the communications on the second channel to the one or more of the second wireless devices, as discussed in FIGS. 2, 3, and 5.

FIG. 8 shows an illustrative flowchart depicting an example operation 800 for wireless communication, according to implementations discussed herein. In some implementations, the example operation 800 may be performed by a first wireless device, such as a station 216 or station 604 shown in FIGS. 2 and 6B, respectively, or discussed in reference to FIGS. 3-5.

As illustrated in FIG. 8, the first wireless device receives a channel switch request from a second wireless device to switch from the first channel to a second channel (810), e.g., as discussed in reference to station 216 and AP 211 in FIG. 2 and discussed in reference to the channel switch request in FIGS. 3-5. In some implementations, the channel switch request may be received via multicast or broadcast.

The first wireless device transmits a response to the second wireless device (820), e.g., as discussed in reference to station 216 and AP 211 in FIG. 2 and discussed in reference to the uplink null frame in FIG. 3 and the acknowledgment in FIG. 5.

The first wireless device receives communications on the second channel from the second wireless device (830), e.g., as discussed in reference to station 216 and AP 211 in FIG. 2 and discussed in reference to the frame exchange in FIGS. 3 and 5.

In some implementations, the first wireless device may detect an overlapping basic service set (OBSS) on the first channel and transmit a message on the first channel to the second wireless device indicating the overlapping basic service set (OBSS) on the first channel, e.g., as discussed in reference to station 216 in FIG. 2. For example, the message transmitted on the first channel to the second wireless device may use overlapping basic service set packet detect (OBSS-PD) with spatial reuse (SR), e.g., as discussed in reference to station 216 in FIG. 2.

In some implementations, the first wireless device may switch from the first channel to the second channel, and receive a trigger frame on the second channel from the second wireless device to poll wireless devices that switched to the second channel, wherein the response to the second wireless device is transmitted after switching from the first channel to the second channel and receiving the trigger frame, e.g., as discussed in FIGS. 2 and 3. The trigger frame, for example, may be a buffer status report poll (BSRP). The response transmitted to the second wireless device, for example, may be an uplink null frame.

In some implementations, the response may be transmitted before switching to the second channel, e.g., as discussed in FIGS. 2 and 5. The response transmitted to the second wireless device, for example, may be an acknowledgement transmitted in an uplink orthogonal frequency-division multiple access (OFDMA) frame.

In some implementations, the channel switch request may include a maximum time on the second channel, as discussed in FIG. 2. In some implementations, the first wireless device may switch from the second channel back to the first channel after receiving a reverse channel switch request or after the maximum time on the second channel has elapsed, as discussed in FIGS. 2, 3, and 5.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, implementations have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for wireless communication performed by a first wireless device, comprising:
obtaining an indication of interference on a first channel;
transmitting a channel switch request using overlapping basic service set packet detect (OBSS-PD) with spatial reuse (SR) to one or more second wireless devices to switch from the first channel to a second channel;
receiving a response from at least one of the one or more second wireless devices; and
transmitting communications on the second channel to the one or more of the second wireless devices.

2. The method of claim 1, wherein obtaining the indication of interference on the first channel comprises detecting an overlapping basic service set (OBSS) on the first channel.

3. The method of claim 1, wherein obtaining the indication of interference on the first channel comprises receiving a message on the first channel from one of the second wireless devices indicating an overlapping basic service set (OBSS) on the first channel.

4. The method of claim 1, wherein transmitting the channel switch request comprises:
transmitting one of a multicast or broadcast message on the first channel with the channel switch request;
switching from the first channel to the second channel; and
transmitting a trigger frame on the second channel to poll the one or more second wireless devices that switched to the second channel, wherein the response from at least one of the one or more second wireless devices is received after switching from the first channel to the second channel and transmitting the trigger frame.

5. The method of claim 4, wherein the trigger frame is a buffer status report poll (BSRP).

6. The method of claim 4, wherein the response received from the one or more of the second wireless devices is an uplink null frame from each of the one or more of the second wireless devices.

7. The method of claim 1, wherein transmitting the channel switch request comprises:
transmitting one of a multicast or broadcast message on the first channel with the channel switch request; and
switching from the first channel to the second channel after receiving the response from one or more of the second wireless devices;
wherein the communications are transmitted on the second channel to the one or more of the second wireless devices after a channel switch delay.

8. The method of claim 7, wherein the response received from the one or more of the second wireless devices is an acknowledgement transmitted in an uplink orthogonal frequency-division multiple access (OFDMA) frame from each of the one or more of the second wireless devices.

9. The method of claim 1, wherein the channel switch request comprises a maximum time on the second channel.

10. The method of claim 1, further comprising switching from the second channel back to the first channel after transmitting the communications on the second channel to the one or more of the second wireless devices.

11. A wireless communication device, comprising:
one or more processors; and
a memory storing instructions that, when executed by the one or more processors, cause the wireless communication device to:
obtain an indication of interference on a first channel;
transmit a channel switch request using overlapping basic service set packet detect (OBSS-PD) with spatial reuse (SR) to one or more second wireless devices to switch from the first channel to a second channel;
receive a response from at least one of the one or more second wireless devices; and
transmit communications on the second channel to the one or more of the second wireless devices.

12. The wireless communication device of claim 11, wherein the execution of the instructions to obtain the indication of interference on the first channel causes the wireless communication device to detect an overlapping basic service set (OBSS) on the first channel.

13. The wireless communication device of claim 11, wherein the execution of the instructions to obtain the indication of interference on the first channel causes the wireless communication device to receive a message on the first channel from one of the second wireless devices indicating an overlapping basic service set (OBSS) on the first channel.

14. The wireless communication device of claim 11, wherein the execution of the instructions to transmit the channel switch request causes the wireless communication device to:
transmit one of a multicast or broadcast message on the first channel with the channel switch request;
switch from the first channel to the second channel; and
transmit a trigger frame on the second channel to poll the one or more second wireless devices that switched to the second channel, wherein the response from at least one of the one or more second wireless devices is received after switching from the first channel to the second channel and transmitting the trigger frame.

15. The wireless communication device of claim 14, wherein the trigger frame is a buffer status report poll (BSRP).

16. The wireless communication device of claim 14, wherein the response received from the one or more of the second wireless devices is an uplink null frame from each of the one or more of the second wireless devices.

17. The wireless communication device of claim 11, wherein the execution of the instructions to transmit the channel switch request causes the wireless communication device to:
transmit one of a multicast or broadcast message on the first channel with the channel switch request; and
switch from the first channel to the second channel after receiving the response from one or more of the second wireless devices;
wherein the communications are transmitted on the second channel to the one or more of the second wireless devices after a channel switch delay.

18. The wireless communication device of claim 17, wherein the response received from the one or more of the second wireless devices is an acknowledgement transmitted in an uplink orthogonal frequency-division multiple access (OFDMA) frame from each of the one or more of the second wireless devices.

19. The wireless communication device of claim 11, wherein the channel switch request comprises a maximum time on the second channel.

20. The wireless communication device of claim 11, wherein the wireless communication device to further caused to switch from the second channel back to the first channel after transmitting the communications on the second channel to the one or more of the second wireless devices.
